(19) United States
(12) Patent Application Publication
(10) Pub. No.: US 2016/0306203 A1
(43) Pub. Date: Oct. 20, 2016

(54) LIQUID CRYSTAL DISPLAY

(71) Applicant: Samsung Display Co., Ltd., Yongin-City (KR)

(72) Inventors: Hyoung Sub LEE, Yongin-si (KR); Seung-Yeon CHAE, Hwaseong-si (KR); Joo Young YOON, Suwon-si (KR)

(21) Appl. No.: 14/931,615

(22) Filed: Nov. 3, 2015

(30) Foreign Application Priority Data
Apr. 15, 2015 (KR) 10-2015-0053060

(51) Int. Cl. G02F 1/1337; G02F 1/1333; G02F 1/1343; G02F 1/1368

(52) U.S. Cl. CPC G02F 1/1337; G02F 1/1368; G02F 1/133345; G02F 1/134309; G02F 1/133377

(57) ABSTRACT

A liquid crystal display according to an exemplary embodiment of the present inventive concept includes: a substrate including a display area and a non-display area; a thin film transistor disposed on the substrate; an insulating layer disposed on the thin film transistor; a pixel electrode disposed on the insulating layer; a roof layer facing the pixel electrode; a liquid crystal layer formed in a plurality of microcavities disposed between the pixel electrode and the roof layer; and an alignment liquid controlling member disposed in the non-display area , the alignment liquid controlling member being a recess or a protrusion.

### CROSS-REFERENCE TO RELATED APPLICATION

This application claims priority to and the benefit of Korean Patent Application No. 10-2015-0053060 filed in the Korean Intellectual Property Office on Apr. 15, 2015, the entire contents of which are incorporated herein by reference.

### BACKGROUND

(a) Field

The present inventive concept relates to a liquid crystal display.

(b) Description of the Related Art

A liquid crystal display, which is one of the most widely used flat panel displays, includes two sheets of display panels on which electric field generating electrodes such as pixel electrodes, common electrodes, and the like are formed and a liquid crystal layer interposed therebetween.

The liquid crystal display displays an image by applying a voltage to the electric field generating electrodes thereby generate an electric field on the liquid crystal layer, determine an orientation of liquid crystal molecules of the liquid crystal layer, accordingly, and control polarization of incident light.

As one of the liquid crystal displays, a technology of implementing a display by forming a plurality of microcavities in a pixel and filling a liquid crystal into the plurality of microcavities has been developed. Although the liquid crystal display according to the related art uses two sheets of substrates, the above-mentioned technology may reduce a weight, a thickness, and the like of the liquid crystal display by using only one substrate.

An alignment layer is formed in the microcavity, and the alignment layer may be formed by injecting an alignment liquid into the microcavities through a narrow open region. When the alignment liquid which is not injected into the microcavity overflows the microcavity, there is a problem that the alignment liquid flows out an outer part of the liquid crystal display, which causes light leakage defect, or the like. The above information disclosed in this Background section is only for enhancement of understanding of the background of the inventive concept and therefore it may contain information that does not form the prior art that is already known in this country to a person of ordinary skill in the art.

### SUMMARY

The present inventive concept has been made in an effort to provide a liquid crystal display having advantages of having decreased light leakage defect and a narrow bezel.

An exemplary embodiment of the present inventive concept provides a liquid crystal display including: a substrate including a display area and a non-display area; a thin film transistor disposed on the substrate; an insulating layer disposed on the thin film transistor; a pixel electrode disposed on the insulating layer; a roof layer facing the pixel electrode; a liquid crystal layer formed in a plurality of microcavities disposed between the pixel electrode and the roof layer; and an alignment liquid controlling member disposed in the non-display area, the alignment liquid controlling member being a recess or a protrusion.

The liquid crystal display may further include an upper insulating layer disposed on the roof layer, wherein the alignment liquid controlling member is formed in the upper insulating layer.

The alignment liquid controlling member may be formed in three columns.

The upper insulating layer may be made of an inorganic material and the alignment liquid controlling member may be a protrusion protruded from a surface of the upper insulating layer.

The liquid crystal display may further include a lower insulating layer disposed between the microcavity and the roof layer, wherein the alignment liquid controlling member is formed in the lower insulating layer.

The roof layer may be formed so as to cover the microcavity, but not cover the alignment liquid controlling member.

The alignment liquid controlling member may be formed in three columns.

The lower insulating layer may be made of an inorganic material and the alignment liquid controlling member may be a protrusion protruded from a surface of the lower insulating layer.

The alignment liquid controlling member may be formed in the insulating layer.

The roof layer may be formed so as to cover the microcavity, but not cover the alignment liquid controlling member.

The alignment liquid controlling member may be formed in three columns.

The insulating layer may be made of an organic material and the alignment liquid controlling member may be a recess formed in the insulating layer.

The alignment liquid controlling member may be formed in the roof layer.

The alignment liquid controlling member may be formed in three columns.

The roof layer may be made of an organic material and the alignment liquid controlling member may be a recess formed in the insulating layer.

With the liquid crystal display according to an embodiment of the present inventive concept, a flow of an alignment material may be controlled by forming the recess in an outer part, thereby making it possible to minimize the light leakage defect, and a dummy pixel may be removed, thereby making it possible to implement a narrow bezel.

### BRIEF DESCRIPTION OF THE DRAWINGS

FIG. 1 is a plan view showing a liquid crystal display according to an exemplary embodiment of the present inventive concept.

FIG. 2 is an enlarged plan view showing a region A, which is a portion of a plurality of pixels of FIG. 1.

FIG. 3 is a cross-sectional view taken along a cutting line III-III of FIG. 2.

FIG. 4 is a cross-sectional view taken along a cutting line IV-IV of FIG. 2.

FIG. 5 is a cross-sectional view taken along a cutting line V-V of FIG. 1.

FIG. 6 is a diagram schematically showing a peripheral part of an alignment liquid flow controlling recess and a flow of an alignment liquid.

FIG. 7 is a cross-sectional view showing a liquid crystal display according to another exemplary embodiment of the present inventive concept.

FIG. 8 is a cross-sectional view showing a liquid crystal display according to an exemplary embodiment of the present inventive concept.

FIG. 9 is a cross-sectional view showing a liquid crystal display according to an exemplary embodiment of the present inventive concept.

FIG. 10 is a plan view showing a liquid crystal display according to an exemplary embodiment of the present inventive concept.

FIG. 11 is a cross-sectional view showing a liquid crystal display according to an exemplary embodiment of the present inventive concept.

### DETAILED DESCRIPTION OF THE EMBODIMENTS

Hereinafter, exemplary embodiments of the present inventive concept will be described in detail with reference to the accompanying drawings so that those skilled in the art may easily practice the present inventive concept. However, the present inventive concept is not limited to the exemplary embodiments which are described herein, and may be modified in various different ways.

Accordingly, the drawings and description are to be regarded as illustrative in nature and not restrictive. Like reference numerals designate like elements throughout the specification.

In several exemplary embodiments, components having the same configuration will be described representatively in a first exemplary embodiment by the same reference numerals. In exemplary embodiments other than the first exemplary embodiment, only configurations different from those of the first exemplary embodiment will be described.

In addition, since sizes and thicknesses of the respective components shown in the drawings are arbitrarily shown for the convenience of explanation as the thicknesses are exaggerated in order to clearly express several layers and regions in the drawings, the present inventive concept is not necessarily limited to those shown in the drawings.

In addition, in the case in which it is stated that a portion such as a layer, a film, a region, a plate, or the like is present “on”, “over”, and “below” another portion, the portion may be directly formed on the another portion or have other layers interposed therebetween.

In addition, unless explicitly described to the contrary, the word “comprise” and variations such as “comprises” or “comprising”, will be understood to imply the inclusion of stated elements but not the exclusion of any other elements.

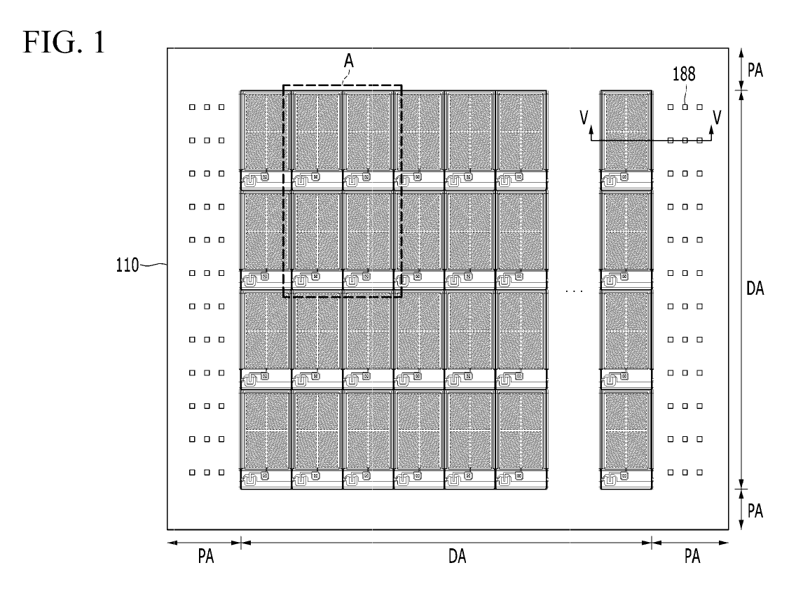

Hereinafter, a liquid crystal display according to an exemplary embodiment of the present inventive concept will be described in detail with reference to FIGS. 1 to 5.

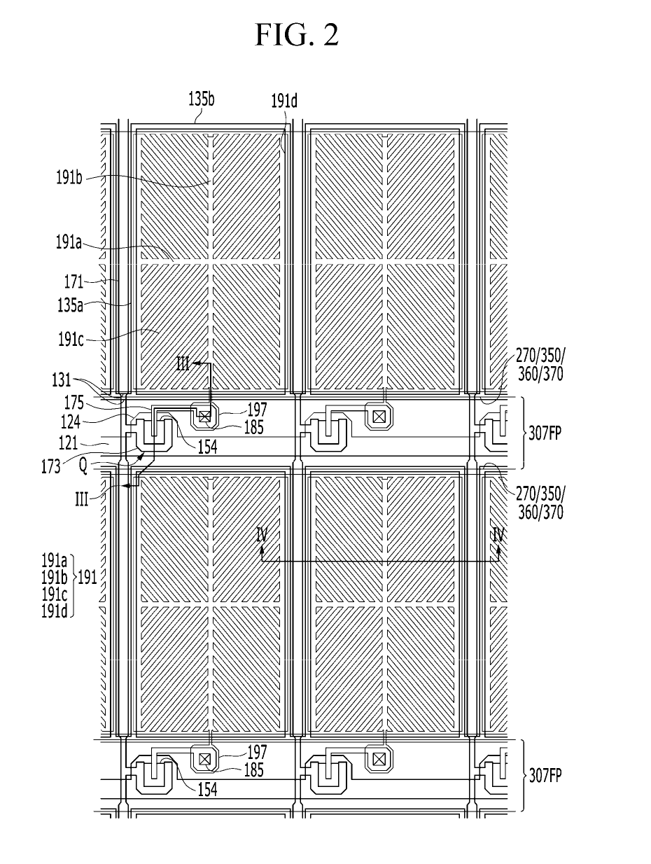

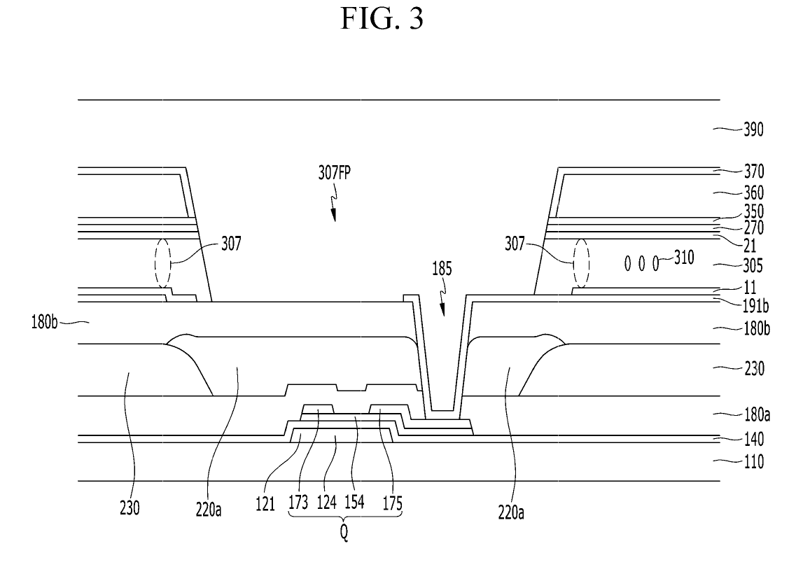

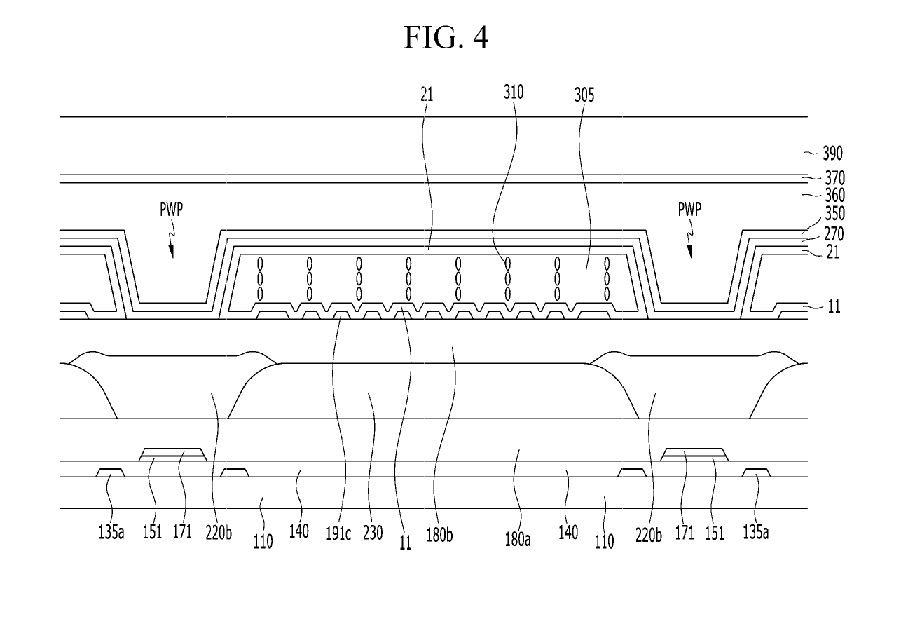

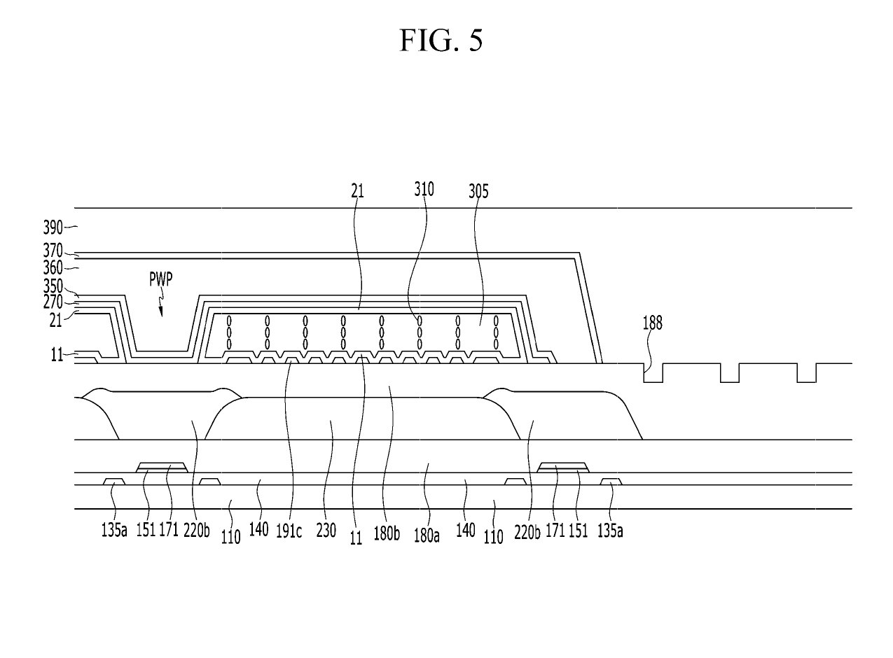

FIG. 1 is a plan view showing a liquid crystal display according to an exemplary embodiment of the present inventive concept and FIG. 2 is an enlarged plan view showing a region A, which is a portion of a plurality of pixels of FIG. 1. The liquid crystal display according to the exemplary embodiment of the present inventive concept may have the pixels which are repeatedly arranged in vertical and horizontal directions. FIG. 3 is a cross-sectional view taken along a cutting line III-III of FIG. 2 and FIG. 4 is a cross-sectional view taken along a cutting line IV-IV of FIG. 2. FIG. 5 is a cross-sectional view taken along a cutting line V-V of FIG. 1.

Referring to FIG. 1, the liquid crystal display includes a display area DA for displaying an image and a non-display area PA for a connection with an external driving circuit.

First, the display area DA of a substrate 110 will be described.

Referring to FIGS. 1 to 4, gate lines 121 and sustain electrode lines 131 are formed on the substrate 110 made of transparent glass, plastic, or the like. The gate line 121 includes a gate electrode 124. The sustain electrode line 131 mainly extends in the horizontal direction and transfers a defined voltage such as a common voltage Vcom, or the like. The sustain electrode line 131 includes a pair of vertical parts 135a that extends substantially perpendicular to the gate line 121 and a horizontal part 135b that connects ends of the pair of vertical parts 135a to each other. The sustain electrodes 135a and 135b have a structure surrounding a pixel electrode 191.

A gate insulating layer 140 is formed on the gate line 121 and the sustain electrode line 131. On the gate insulating layer 140, a semiconductor layer 151 disposed below a data line 171, and a semiconductor layer 154 which is disposed below a source/drain electrode and at a channel portion of a thin film transistor Q are formed.

A plurality of ohmic contacts may be formed on the respective semiconductor layers 151 and 154 and between the data line 171 and the source/drain electrode, but are omitted in the drawings.

Data conductors 171, 173, and 175 including a source electrode 173, the data line 171 connected to the source electrode 173, and the drain electrode 175 are formed on the respective semiconductor layers 151 and 154 and the gate insulating layer 140.

The gate electrode 124, the source electrode 173, and the drain electrode 175 form the thin film transistor Q together with the semiconductor layer 154, and a channel of the thin film transistor Q is formed in the semiconductor layer 154 between the source electrode 173 and the drain electrode 175.

A first interlayer insulating layer 180a is formed on the data conductors 171, 173, and 175 and the exposed semiconductor layer part 154. The first interlayer insulating layer 180a may include an inorganic insulating material such as silicon nitride (SiNx) or silicon oxide (SiOx), or an organic insulating material.

A color filter 230 and light blocking members 220a and 220b are formed on the first interlayer insulating layer 180a.

The light blocking members 220a and 220b are formed to have a lattice structure having an opening corresponding to an area displaying an image and are formed of a material through which light is not transmitted. The color filter 230 is formed in the opening of the light blocking members 220a and 220b. However, the light blocking members 220a and 220b may be formed after forming the color filter 230. The light blocking members 220a and 220b include a horizontal light blocking member 220a formed along a direction which is parallel to the gate line 121 and a vertical light blocking member 220b formed along a direction which is parallel to the data line 171.

The color filter 230 may display one of primary colors such as the three primary colors of red, green and blue. However, the colors that the color filter 230 may display are not limited to the three primary colors such as red, green, and blue. For example, the color filter 230 may also display one of cyan, magenta, yellow, and white. The color filter 230 may be formed of a material that displays different colors for each of pixels which are adjacent to each other.

The light blocking members 220a and 220b may be omitted, and overlapped color filters, an electrode material, or the like may serve as the light blocking members 220a and 220b.

A second interlayer insulating layer 180b covering the color filter 230 and the light blocking members 220a and 220b is formed on the color filter 230 and the light blocking members 220a and 220b. The second interlayer insulating layer 180b may include an inorganic insulating material such as silicon nitride (SiNx) or silicon oxide (SiOx), or an organic insulating material.

In a case in which a step occurs by a thickness difference between the color filter 230 and the light blocking members 220a and 220b, the step may be reduced or removed by allowing the second interlayer insulating layer 180b to include the organic insulating material.

Contact holes 185 that expose the drain electrode 175 may be formed in the color filter 230, the light blocking members 220a and 220b, and the interlayer insulating layers 180a and 180b.

The pixel electrode 191 is disposed on the second interlayer insulating layer 180b. The pixel electrode 191 may be made of a transparent conductive material such as ITO, IZO, or the like.

The pixel electrode 191 has an overall shape of quadrangle and includes a cross stem part including a horizontal stem part 191a and a vertical stem part 191b intersecting with the horizontal stem part 191a. In addition, the pixel electrode 191 is partitioned into four sub-regions by the horizontal stem part 191a and the vertical stem part 191b and each of the sub-regions includes a plurality of fine branch parts 191c. Further, according to the present exemplary embodiment, the pixel electrode 191 may further include outer stem parts 191d connecting the fine branch parts 191c at left and right outer parts of the pixel electrode 191. According to the present exemplary embodiment, the outer stem parts 191d are disposed at the left and right outer parts of the pixel electrode 191, but may be disposed to connect an upper portion or a lower portion of the pixel electrode 191.

The fine branch part 191c of the pixel electrode 191 forms an angle of approximately 40° to 45° with the gate line 121 or the horizontal stem part. In addition, the fine branch parts of two neighboring sub-regions may be perpendicular to each other. In addition, the fine branch part may have a width which is gradually increased, or an interval between the fine branch parts 191c may be different.

The pixel electrode 191 includes an extension part 197 connected to a lower end of the vertical stem part 191b and having an area wider than that of the vertical stem part 191b, is physically and electrically connected to the drain electrode 175 through the contact hole 185 in the extension part 197, and is applied with a data voltage from the drain electrode 175.

The description of the thin film transistor Q and the pixel electrode 191 described above is one example, and in order to improve side visibility, a structure of the thin film transistor and a design of the pixel electrode are not limited to the structure described in the present exemplary embodiment, but may be modified.

A lower alignment layer 11 is formed on the pixel electrode 191 and the lower alignment layer 11 may be a vertical alignment layer. The lower alignment layer 11 may be formed to include at least one of materials which are generally used in a liquid crystal alignment layer such as polyimide (PI), polysiloxane, polyamic acid, or the like.

An upper alignment layer 21 is disposed at a portion facing the lower alignment layer 11 and a microcavity 305 is formed between the lower alignment layer 11 and the upper alignment layer 21. The microcavity 305 is injected with a liquid crystal material 310 including liquid crystal molecules, and the microcavity 305 has an inlet part 307. A plurality of microcavities 305 may be formed along a column direction of the pixel electrode 191, that is, the vertical direction. According to the present exemplary embodiment, an alignment material forming the alignment layers 11 and 21, and the liquid crystal material 310 including the liquid crystal molecules may be injected into the microcavity 305 using capillary force. According to the present exemplary embodiment, the lower alignment layer 11 and the upper alignment layer 21 are merely distinguished from each other depending on a position thereof, and may be connected to each other as shown in FIG. 4. The lower alignment layer 11 and the upper alignment layer 21 may be simultaneously formed.

The microcavity 305 is partitioned in a vertical direction by a plurality of trenches 307FP positioned at portions which are overlapped with the gate line 121, to thereby form the plurality of microcavities 305, and the plurality of microcavities 305 may be formed along the column direction of the pixel electrode 191, that is, the vertical direction. In addition, the microcavity 305 is partitioned in a horizontal direction by a partition wall part PWP to be described below, to thereby form the plurality of microcavities 305, and the plurality of microcavities 305 may be formed along a row direction of the pixel electrode 191, that is, a horizontal direction in which the gate line 121 extends. Each of the plurality of microcavities 305 formed as described above may correspond to one pixel region, or two or more pixel regions, and the pixel region may correspond to a region that displays a color of an image.

A common electrode 270 and a lower insulating layer 350 are disposed on the upper alignment layer 21. The common electrode 270 is applied with the common voltage and generates an electric field together with the pixel electrode 191 applied with the data voltage, to thereby determine a direction in which the liquid crystal material 310 disposed in the microcavity 305 between the two electrodes is tilted. The common electrode 270 forms a capacitor together with the pixel electrode 191, to thereby maintain the applied voltage even after the thin film transistor is turned-off. The lower insulating layer 350 may be formed of silicon nitride (SiNx) or silicon oxide (SiO₂).

The present exemplary embodiment describes the case in which the common electrode 270 is formed on the microcavity 305, but according to another exemplary embodiment, the common electrode 270 may be formed below the microcavity 305, thereby making it possible to drive the liquid crystal according to a horizontal electric field mode, for example, in-plane switching IPS mode or plane-to-line switching PLS mode.

A roof layer 360 is disposed on the lower insulating layer 350. The roof layer 360 serves as a supporter so that the microcavity 305, which is a space between the pixel electrode 191 and the common electrode 270, may be formed. The roof layer 360 may include photoresist or other organic materials.

The upper insulating layer 370 is disposed on the roof layer 360. The upper insulating layer 370 may be in contact with an upper surface of the roof layer 360. The upper insulating layer 370 according to the present exemplary embodiment may include an inorganic insulating material such as silicon nitride (SiNx) or silicon oxide (SiOx), or an organic insulating material.

As shown in FIG. 3, the upper insulating layer 370 may cover side portions of the roof layer 360. As a modified example, side walls of the lower insulating layer 350, the roof layer 360, and the upper insulating layer 370 may be formed so as to be substantially equally aligned with each other.

A capping layer 390 is disposed on the upper insulating layer 370. The capping layer 390 includes an organic material or an inorganic material. According to the present exemplary embodiment, the capping layer 390 may be disposed in the trench 307FP as well as on the upper insulating layer 370. In this case, the capping layer 390 may cover the inlet part 307 of the microcavity 305 exposed by the trench 307FP. Although the present exemplary embodiment describes the case in which the liquid crystal material is removed from the trench 307FP, the liquid crystal material may remain in the trench 307FP after injecting the liquid crystal material into the microcavities 305.

According to the present exemplary embodiment, as shown in FIG. 4, a partition wall part PWP is formed between the microcavities 305 which are adjacent to each other in the horizontal direction. The partition wall part PWP may be formed along a direction in which the data line 171 extends and may be covered by the roof layer 360. The partition wall part PWP may be formed by the common electrode 270, the lower insulating layer 350, the roof layer 360, and the upper insulating layer 370. The above-mentioned structures may form partition walls, thereby making it possible to partition or define the microcavity 305. According to the present exemplary embodiment, since the partition wall structure such as the partition wall part PWP is present between the microcavities 305, even in a case in which the substrate 110 is bent, stress occurring by the bending of the substrate 110 may be minimized and a change of a cell gap may be reduced.

Although not shown, a polarizer may be formed on outer surface portions of the substrate 110 and the capping layer 390.

Next, the non-display area PA of the substrate 110 will be described.

Referring to FIGS. 1 and 5, in the non-display area PA, the gate insulating layer 140, the first interlayer insulating layer 180a, and the second interlayer insulating layer 180b extending from the display area DA may be sequentially disposed on the substrate 110. An alignment liquid controlling member may be formed on the second interlayer insulating layer 180b. The alignment liquid controlling member may be alignment liquid flow controlling recesses 188 formed in the second interlayer insulating layer 180b, alignment liquid controlling protrusions 189 protruded from a surface of the second interlayer insulating layer 180b, or the like. Hereinafter, an exemplary embodiment in which the alignment liquid flow controlling recesses 188 are formed in the second insulating layer 180b will be described.

The alignment liquid flow controlling recess 188 are formed in the second interlayer insulating layer 180b. According to the present exemplary embodiment, the alignment liquid flow controlling recesses 188 are formed at a left side and a right side of the display area DA on the non-display area PA. The alignment liquid flow controlling recesses 188 may be arranged to form a stripe shape recess extending parallel to the data line 171. The stripe shape recess may include a plurality of stripe shape recesses arranged parallel to each other, for example, two stripe shape recesses. The arrangement, number, shape, etc. of the alignment liquid flow controlling recesses 188 in the present exemplary embodiment are merely examples, and the alignment liquid flow controlling recesses 188 may be modified in other forms. For example, the alignment liquid flow controlling recesses 188 may be three or more stripe shaped recesses. In addition, the positions at which the alignment liquid flow controlling recesses 188 are formed are not limited to the left and right side of the display area DA. For example, the alignment liquid flow controlling recesses 188 may be formed in other positions as long as they are in the non-display area PA, for example, a top side and/or a bottom side of the display area DA. The shape of the alignment liquid flow controlling recesses 188 may be a circular shape, a quadrangular shape, or the like, but is not limited thereto. An interval at which the alignment liquid flow controlling recesses 188 are disposed may not be regular.

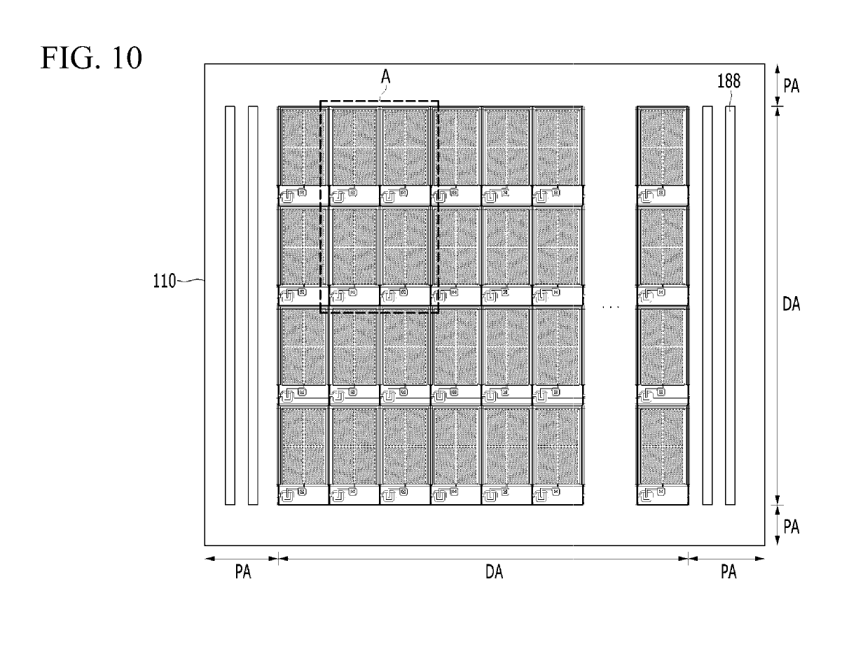

The alignment liquid flow controlling recesses 188 may be two stripe shaped recesses which extend along a direction parallel to the data line 171 and disposed on the left side and the right side of the display area DA, respectively, as shown in FIG. 10. Each of the two stripe shaped recesses may include a plurality of stripe shaped recesses arranged along a direction parallel to the data line 171. The each of the two stripe shaped recesses may include more than two stripe shaped recesses, for example, three stripe shaped recesses. The plurality of stripe shaped recesses arranged along a direction parallel to the data line 171 may be connected to each other via a plurality of connecting recesses which connect the adjacent recesses.

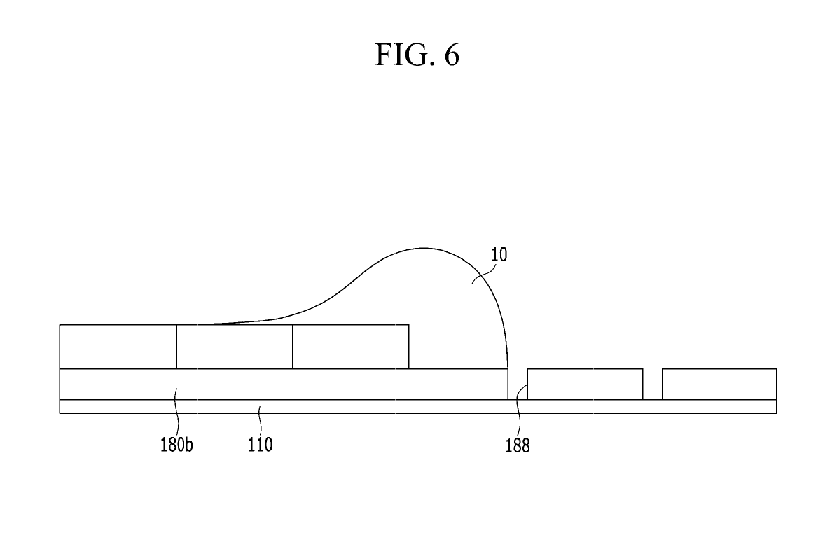

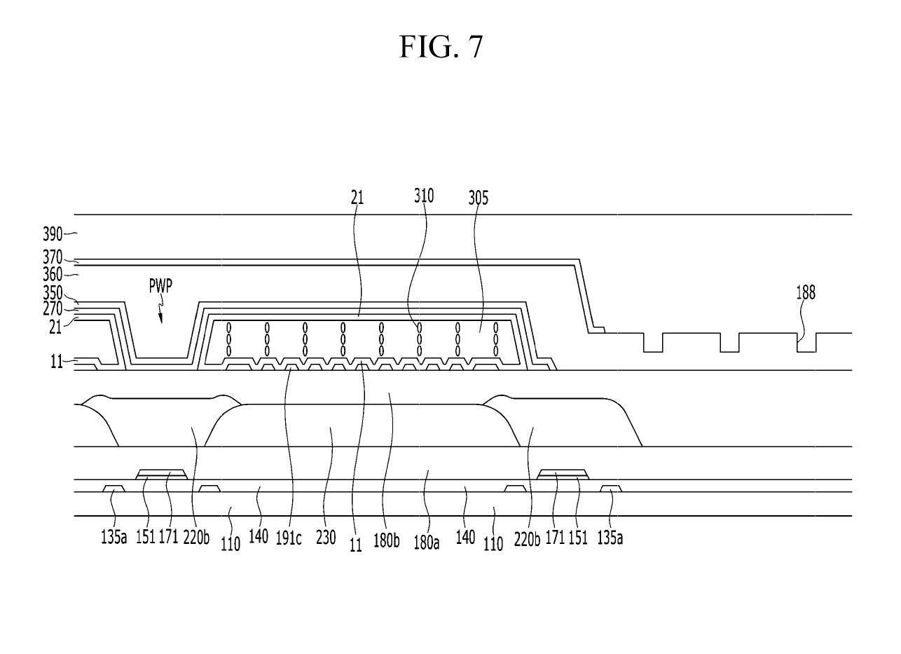

The lower insulating layer 350, the roof layer 360, and the upper insulating layer 370 may not be formed in the non-display area PA, and the capping layer 390 may be formed on the second interlayer insulating layer 180b. However, according to another exemplary embodiment of the present inventive concept, as shown in FIG. 7, the roof layer 360 may be formed so as to extend up to the non-display area PA, and the alignment liquid flow controlling recesses 188 may be formed in the roof layer 360. FIG. 7 is a cross-sectional view showing a liquid crystal display according to an exemplary embodiment of the present inventive concept. In this case, the roof layer 360 may be formed of an organic material. Hereinafter, an effect of the alignment liquid flow controlling recesses 188 will be described with reference to FIG. 6. FIG. 6 is a diagram schematically showing a peripheral part of the alignment liquid flow controlling recessed 188 and a flow of an alignment liquid 10.

The alignment layers 11 and 21 are formed by injecting the alignment liquid 10 including at least one of materials which are generally used in the liquid crystal alignment layer such as polyimide PI, polysiloxane, polyamic acid, or the like through the inlet part 307, and then performing a bake process. In this case, the alignment liquid 10 left after being injected into the microcavities 305 through the inlet part 307 may overflow the microcavity 305 onto the non-display area PA. In this case, as shown in FIG. 6, the alignment liquid 10 does not overflow the alignment liquid flow controlling recesses 188 and is blocked by the alignment liquid flow controlling recesses 188. Without the alignment liquid flow controlling recesses 188, a light leakage defect problem occurs due to the overflown alignment liquid 10 to the non-display area PA. By forming the alignment liquid flow controlling recesses 188, even if an amount of the alignment liquid 10 overflown is increased, the overflown alignment liquid 10 is trapped in the alignment liquid flow controlling recesses 188. Thus, a light leakage defect problem occurring due to overflown alignment liquid 10 may be prevented. In addition, dummy pixels and trenches which connect TFT forming areas to each other formed in the non-display area PA in order to control light leakage defect may be a limitation for implementing a narrow bezel. However, according to the present exemplary embodiment, since the dummy pixels and the trenches in the nod-display area may be omitted, a narrower bezel may be implemented.

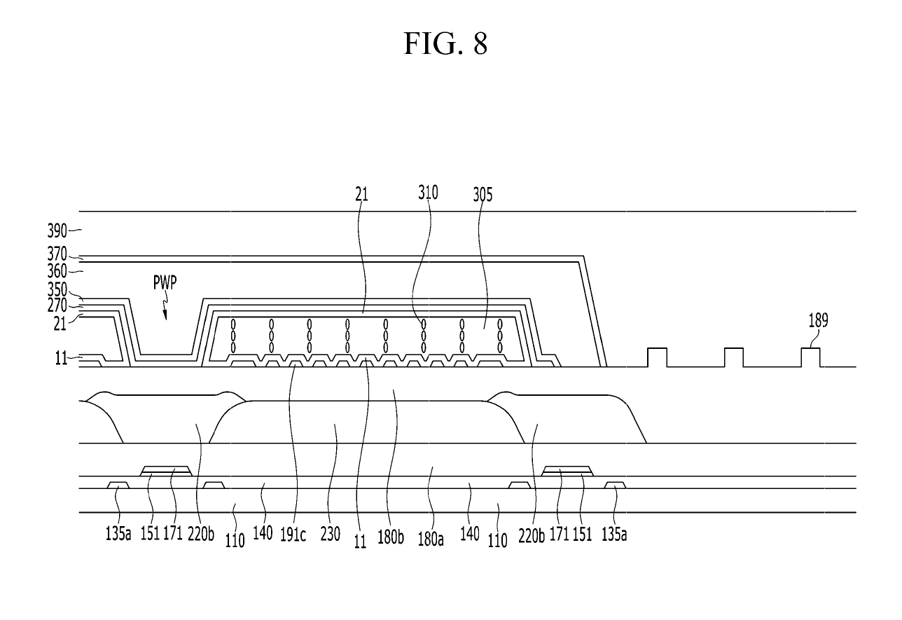

Hereinafter, a liquid crystal display according to an exemplary embodiment of the present inventive concept will be described with reference to FIG. 8. FIG. 8 is a cross-sectional view showing a liquid crystal display according to an exemplary embodiment of the present inventive concept.

Since the description of the display area DA is the same as that of the exemplary embodiment described in FIGS. 2 to 4, it may be applied to the present exemplary embodiment. Hereinafter, the non-display area PA will be described.

Referring to FIG. 8, in the non-display area PA, the gate insulating layer 140, the first interlayer insulating layer 180a, and the second interlayer insulating layer 180b are extended from the display area DA and are sequentially stacked on the substrate 110.

The alignment liquid flow controlling protrusions 189 are formed in the second interlayer insulating layer 180b. According to the present exemplary embodiment, the alignment liquid flow controlling protrusions 189 are formed at a left side and/or a right side of the display area DA on the non-display area PA. The alignment liquid flow controlling protrusions 189 may be one stripe shaped protrusion which extends along a direction parallel to the data line 171. The alignment liquid flow controlling protrusion 189 may be disposed on the left side and the right side of the display area DA. The alignment liquid flow controlling protrusion 189 may include more than two stripe shaped protrusions, for example, three stripe shaped protrusions. The arrangement, number, shape, etc. of the alignment liquid flow controlling protrusions 189 in the present exemplary embodiment are merely examples, and the alignment liquid flow controlling protrusions 189 may be modified in other forms. For example, the alignment liquid flow controlling protrusions 189 may be three or more stripes and may also be three stripes or less. In addition, the positions at which the alignment liquid flow controlling protrusions 189 are formed are not limited to the left and right of the plurality of pixel regions. For example, the alignment liquid flow controlling protrusions 189 may be formed in other positions as long as they are in the non-display area PA, for example, a top side and/or a bottom side of the display area DA. The shape of the alignment liquid flow controlling protrusion 189 may be a circular shape, a quadrangular shape, a line shape, but is not limited thereto, and an interval at which the alignment liquid flow controlling protrusions 189 are disposed may not be regular. Similar to the alignment liquid flow controlling recesses 188, the alignment liquid flow controlling protrusion 189 controls the overflow of the alignment liquid.

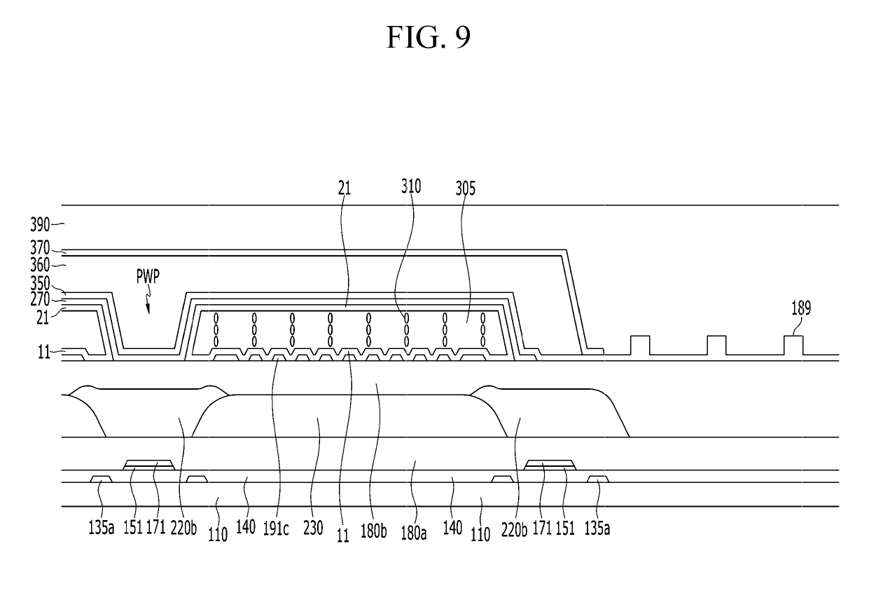

The lower insulating layer 350, the roof layer 360, and the upper insulating layer 370 are not formed in the non-display area PA, and the capping layer 390 is formed on the second interlayer insulating layer 180b. However, according to another exemplary embodiment of the present inventive concept, as shown in FIG. 9, the lower insulating layer 350 may extend up to the non-display area PA, and the alignment liquid flow controlling protrusions 189 may be formed in the lower insulating layer 350. FIG. 9 is a cross-sectional view showing a liquid crystal display according to an exemplary embodiment of the present inventive concept. In this case, the lower insulating layer 350 may be formed of an inorganic material.

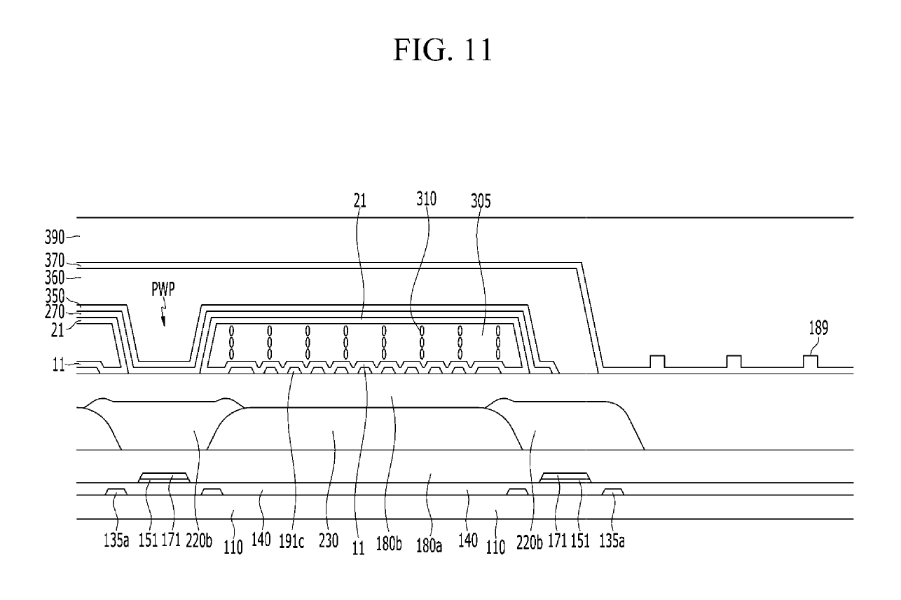

In addition, according to another exemplary embodiment of the present inventive concept, as shown in FIG. 11, the upper insulating layer 370 may be formed so as to extend up to the non-display area PA and the alignment liquid flow controlling protrusions 189 may also be formed in the upper insulating layer 370. In this case, the upper insulating layer 370 may be formed of the inorganic material.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A liquid crystal display comprising:
a substrate including a display area and a non-display area;
a thin film transistor disposed on the substrate;
an insulating layer disposed on the thin film transistor;
a pixel electrode disposed on the insulating layer;
a roof layer facing the pixel electrode;
a liquid crystal layer formed in a plurality of microcavities disposed between the pixel electrode and the roof layer; and
an alignment liquid controlling member disposed in the non-display area, the alignment liquid controlling member being a recess or a protrusion.

2. The liquid crystal display of claim 1, further comprising:
an upper insulating layer disposed on the roof layer, wherein the alignment liquid controlling member is formed in the upper insulating layer.

3. The liquid crystal display of claim 2, wherein:
the alignment liquid controlling member is formed in three columns.

4. The liquid crystal display of claim 3, wherein:
the upper insulating layer is made of an inorganic material and the alignment liquid controlling member is a protrusion protruded from a surface of the upper insulating layer.

5. The liquid crystal display of claim 2, wherein:
the upper insulating layer is made of an inorganic material and the alignment liquid controlling member is a protrusion protruded from a surface of the upper insulating layer.

6. The liquid crystal display of claim 1, further comprising:
a lower insulating layer disposed between the microcavity and the roof layer, wherein the alignment liquid controlling member is formed in the lower insulating layer.

7. The liquid crystal display of claim 6, wherein:
the roof layer is formed so as to cover the microcavity, but not cover the alignment liquid controlling member.

8. The liquid crystal display of claim 7, wherein:
the alignment liquid controlling member is formed in three columns.

9. The liquid crystal display of claim 8, wherein:
the lower insulating layer is made of an inorganic material and the alignment liquid controlling member is a protrusion protruded from a surface of the lower insulating layer .

10. The liquid crystal display of claim 7, wherein:
the lower insulating layer is made of an inorganic material and the alignment liquid controlling member is a protrusion protruded from a surface of the lower insulating layer .

11. The liquid crystal display of claim 1, wherein:
the alignment liquid controlling member is formed in the insulating layer.

12. The liquid crystal display of claim 11, wherein:
the roof layer is formed so as to cover the microcavity, but not cover the alignment liquid controlling member.

13. The liquid crystal display of claim 12, wherein:
the alignment liquid controlling member is formed in three columns.

14. The liquid crystal display of claim 13, wherein:
the insulating layer is made of an organic material and the alignment liquid controlling member is a recess formed in the insulating layer .

15. The liquid crystal display of claim 12, wherein:
the insulating layer is made of an organic material and the alignment liquid controlling member is a recess formed in the insulating layer .

16. The liquid crystal display of claim 1, wherein:
the alignment liquid controlling member is formed in the roof layer.

17. The liquid crystal display of claim 16, wherein:
the alignment liquid controlling member is formed in three columns.

18. The liquid crystal display of claim 17, wherein:
the roof layer is made of an organic material and the alignment liquid controlling member is a recess formed in the roof layer .

19. The liquid crystal display of claim 16, wherein:
the roof layer is made of an organic material and the alignment liquid controlling member is a recess formed in the roof layer .
